(19) United States
(12) Patent Application Publication
(10) Pub. No.: US 2004/0090558 A1
(43) Pub. Date: May 13, 2004

(54) Video signal processor

(75) Inventors: Tatsuya Takahashi, Ogaki-Shi (JP); Tohru Watanabe, Ogaki-Shi (JP); Osamu Tabata, Gifu-Shi (JP)

Correspondence Address: HOGAN & HARTSON L.L.P., 500 S. GRAND AVENUE, SUITE 1900, LOS ANGELES, CA, 90071-2611, US

(73) Assignee: SANYO ELECTRIC CO., LTD.

(21) Appl. No.: 10/648,043

(22) Filed: Aug. 26, 2003

(30) Foreign Application Priority Data
Aug. 27, 2002 (JP) 2002-246554

(51) Int. Cl. H04N 5/18

(52) U.S. Cl. 348/691; 348/689; 348/684

(57) ABSTRACT

An AGC circuit (70) amplifies a video signal according to again value output from again setting circuit (56). A clamp circuit (72) performs clamping of the direct current level of an output signal from the AGC circuit (70) at a clamp ability level according to a time constant set by a clamp time constant setting circuit (58). The clamp time constant setting circuit (58) receives input of the gain value generated by the gain setting circuit (56). A comparator circuit (120) compares the received gain value to a reference value, and, when the gain value exceeds the reference value, outputs a relatively large time constant. The clamp ability level of the clamp circuit (72) is controlled according to this time constant. In this manner, when the gain value is large, gradual clamping can be executed so as to minimize the influence of noise components superimposed on the direct current level, thereby suppressing transverse noise.

### BACKGROUND OF THE INVENTION

1. Field of the Invention

The present invention relates to a video signal processor for processing a video signal output from an imaging element, and more particularly to control of the direct current level of a video signal.

2. Description of the Related Art

A video signal obtained using an imaging element such as a CCD (charge coupled device) image sensor is typically extracted by coupling the signal using a capacitor. The direct current level of the video signal may therefore be varied according to the video signal level. Accordingly, clamp processing is performed to achieve a predetermined black level in the video signal (OPB video signal) corresponding to an optical black (OPB) region provided in a peripheral portion of a pixel array of the imaging element. Further, the direct current level of a video signal output from an AGC (automatic gain control) circuit provided in a subsequent stage may be varied according to the gain of the AGC circuit. A clamp circuit is therefore provided after the AGC circuit to control the direct current level.

FIG. 6 is a schematic circuit diagram illustrating a related art video signal processor. This device comprises an analog signal processing circuit 2, a digital signal processing circuit 6, and a gain setting circuit 8. In the analog signal processing circuit 2, an AGC circuit 20 controls the video signal level by applying a gain which is set in a gain setting circuit 8 to a video signal received from a CCD image sensor. The output from the AGC circuit 20 is then clamped by a clamp circuit 22. In the digital signal processing circuit 6, an integration circuit 24 integrates the video signal corresponding to one screen image. A judgment circuit 26 compares the integrated result to a predetermined reference value. The gain setting circuit 8 adjusts the gain according to the result of the comparison. In this manner, feedback control is performed so as to maintain the average level of the video signal within a predetermined range for a unit of one screen image.

The clamp circuit 22 connects the signal line to a reference voltage source for a given period within an OPB video signal period in synchronization with a horizontal synchronization signal HD. The direct current level of the video signal is thus clamped at a predetermined voltage, allowing the black level to be set at a uniform level. The clamp time constant of the clamp circuit 22 is determined by a clamp pulse CL generated in a clamp pulse generating circuit 28. More specifically, the clamp pulse generating circuit 28 adjusts the current amount supplied from the reference voltage source to the signal line during each clamp operation. For example, the time constant is reduced when the current amount supplied in one clamp operation is increased, and, as a result, the direct current level is speedily converged to the voltage of the reference voltage source.

An OPB video signal can include noise components. When the direct current level having superimposed noise components is clamped, the direct current level after clamping is fluctuated in accordance with the noise components. In other words, in every horizontal line, the direct current level after clamping varies due to the influence of changing noise components. This appears as a transverse noise in a reproduced image. The degree of fluctuation in accordance with the noise components depends on the clamp time constant. For example, when the clamp time constant is relatively small, the direct current level after clamping is more likely to fluctuate in accordance with the noise components that were present during the clamp period. That is, from the aspect that clamping to a predetermined level can be gradually performed over a relatively large number of lines to reduce transverse noise, the clamp time constant is preferably set at a large value. However, from the aspect that convergence to the black level can be speedily achieved, the clamp time constant is preferably set at a small value. In consideration of these factors, the clamp time constant is conventionally set at a constant value which best enables the obtaining of desirable reproduced images under actual use conditions of the device.

The degree of fluctuation in accordance with the noise components depends not only on the clamp time constant but also on the magnitude of noise components. The magnitude of noise components included in the video signal output from an amplifier circuit depends on the gain of the amplifier circuit. In conventional clamp processing performed on the output side of the amplifier circuit, the clamp time constant is set without considering the changes in noise components generated in accordance with changes in the gain. For this reason, there exists the problem that clamping becomes unstable when the gain is increased, which likely causes transverse noise.

### SUMMARY OF THE INVENTION

An advantage of the present invention is that it achieves successful clamping of the direct current level of a video signal, allowing to obtain a high-quality image.

A video signal processor according to the present invention comprises an amplifier circuit for applying a desired gain to a video signal that is continuous for a unit of one screen image, and a clamp circuit for clamping a reference level of the amplified video signal to a predetermined level, wherein a time constant used for the clamping of the video signal in the clamp circuit is variably set according to the applied gain.

According to the present invention, when the gain of the amplifier circuit is set to a relatively large value, the time constant is also set at a larger value. The changes in the time constant according to the gain can be continuous or stepwise. When the gain is increased, the time constant is increased to prevent the direct current level from being fluctuated in accordance with noise components, thereby suppressing generation of transverse noise. The time constant of the clamp circuit for shifting the direct current level to the predetermined level depends on the clamp ability level of the circuit. When the clamp ability level is decreased by reducing the clamp pulse width or by reducing the current supplied by the clamp power source, the time constant is increased.

In the present invention, the clamp circuit of the video signal processor may clamp the video signal in response to a clamp pulse, and the pulse width of the clamp pulse may be adjusted so as to variably set the clamp time constant.

In another preferred configuration of the present invention, the video signal processor may further comprise a comparison circuit for comparing a gain value indicating the gain amount of the amplifier circuit to a predetermined reference value, and a clamp pulse generating circuit for adjusting the pulse width of the clamp pulse in accordance with a comparison result obtained in the comparison circuit.

In a further video signal processor according to the present invention, the comparison circuit includes a first and second reference values, and exhibits a hysteresis characteristic when performing comparison of the first and second reference values to the gain value.

According to the present invention, a hysteresis characteristic is imparted to the changes in the time constant with respect to the gain. For example, it is assumed that the second reference value is set higher than the first reference value. During reduction of the gain, when the gain becomes lower than the second reference value, the pulse width of the clamp pulse is maintained at the current width corresponding to a relatively large clamp time constant, and, when the gain becomes lower than the first reference value, the pulse width is switched to a width corresponding to a small time constant. On the other hand, during increase of the gain, the pulse width corresponding to a small time constant is maintained when the gain exceeds the first reference value, and, when the gain exceeds the second reference value, the pulse width is switched to a width corresponding to a large time constant. This hysteresis characteristic prevents excessive switching of the clamp time constant when the gain is varied in the vicinity of the first and the second reference values, thereby avoiding frequent changes in image quality caused by such switching.

### BRIEF DESCRIPTION OF THE DRAWINGS

FIG. 1 is a block diagram illustrating a schematic circuit configuration of a video signal processor according to an embodiment of the present invention.

FIG. 2 is a timing chart illustrating an example operation of the present device.

FIGS. 3 is an enlarged view of a waveform of a CLP output signal when the clamp ability is set to a high level.

FIG. 4 is an enlarged view of a waveform of a CLP output signal when the clamp ability is set to a low level.

FIG. 5 is a schematic diagram showing a pixel arrangement of a CCD image sensor which inputs a video signal into the present device.

FIG. 6 is a schematic circuit diagram showing a related art video signal processor.

FIG. 7 is a diagram illustrating the relationship between gain G and clamp time constant I.

### DESCRIPTION OF THE PREFERRED EMBODIMENT

A preferred embodiment of the present invention will now be described with reference to the accompanying drawings.

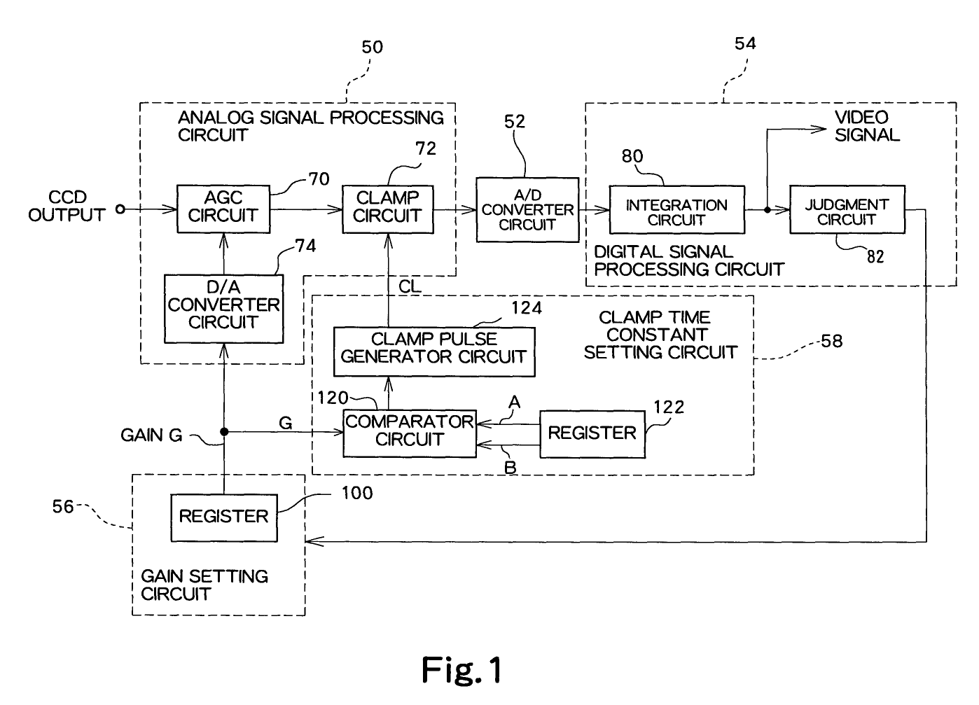

FIG. 1 is a block diagram illustrating a schematic circuit configuration of a video signal processor according to an embodiment of the present invention. This device comprises an analog signal processing circuit 50, A/D (analog-to-digital) converter circuit 52, digital signal processing circuit 54, gain setting circuit 56, and clamp time constant setting circuit 58.

The analog signal processing circuit 50 includes an AGC circuit 70, clamp circuit 72, and D/A (digital-to-analog) converter circuit 74. The AGC circuit 70 receives input of a video signal from a CCD image sensor, and amplifies the video signal in accordance with a gain supplied by the gain setting circuit 56. The clamp circuit 72 is a circuit for clamping the direct current level of the video signal amplified in the AGC circuit 70. In synchronization with a horizontal synchronization signal HD generated in a timing control circuit (not shown) for driving the CCD, the clamp circuit 72 performs a clamp operation in an OPB video signal period of each horizontal line. The time constant for the clamp operation is set by the clamp time constant setting circuit 58. More specifically, the clamp circuit 72 includes a reference voltage source having a voltage corresponding to a reference black level, and a switch for connecting the reference voltage source to the video signal line. The switch is configured so as to be turned on by a clamp pulse CL. The clamp ability level of the clamp circuit 72 is changed according to the designated time constant.

The clamp ability level may be changed by, for example, adjusting the width of the clamp pulse which turns on the switch connecting the reference voltage source and the video signal line, or by controlling the current supplying ability of the reference voltage source. Specifically, by increasing the clamp pulse width or the current supplying ability, the amount of current supplied from the reference voltage source to the video signal line in one clamp operation can be increased, thereby augmenting the clamp ability level.

In general, the clamp time constant is set inversely proportional to the clamp ability level. Accordingly, the changing or setting of the clamp time constant is basically equivalent to setting or changing the clamp ability level. For example, when the clamp time constant is set to a smaller value, the clamp ability level is increased, and the potential of the OPB video signal corresponding to the black level rapidly converges (that is, converges in a fewer number of clamp operations) at the voltage of the reference voltage source.

After the direct current level of the video signal is adjusted in the clamp circuit 72, the video signal is converted into a digital signal by the A/D converter circuit 52, and subsequently input to the digital signal processing circuit 54.

The digital signal processing circuit 54 may be configured to perform, with respect to the digital video signal, various image processing procedures such as the processing for generating a luminance signal and a color-difference signal. In FIG. 1, however, the digital signal processing circuit 54 is shown including only an integration circuit 80 and judgment circuit 82 related to the gain feedback control of the present video signal processor. The integration circuit 80 may calculate the integral of the video signal for one screen image. The judgment circuit 82 compares the integral obtained in the integration circuit 80 to a predetermined target range. When the integral is below the target range, a judgment for increasing the gain is output. When the integral exceeds the target range, a judgment for decreasing the gain is output. When the integral is within the target range, a judgment for maintaining the current gain is output. As one example of the above-referenced various signal processing, the integral obtained in the integration circuit 80 may be used for auto-iris control.

The judgment result generated in the judgment circuit 82 is supplied to the gain setting circuit 56. A plurality of gain values for the AGC circuit 70 are stored in advance in a register 100 in the gain setting circuit 56. In accordance with the supplied judgment result, one of these gain values is read out and output. The gain setting circuit 56 may save in a memory the most recently read out address of the register 100. When the judgment result instructs an increase in the gain, the gain setting circuit 56 designates an address which stores a gain value larger than the gain value stored in the saved address, and reads out this larger gain value. On the other hand, when the judgment result instructs a reduction in the gain, the gain setting circuit 56 outputs a gain value smaller than the current gain value. The gain setting circuit 56 performs no processing for reading out a new gain value when it receives an instruction to maintain the current gain.

The gain value is output from the gain setting circuit 56 as a digital value, then converted into an analog signal by the D/A converter circuit 74. The AGC circuit amplifies the video signal in accordance with this analog gain signal.

The gain output from the gain setting circuit 56 is also supplied to the clamp time constant setting circuit 58. The clamp time constant setting circuit 58 comprises a comparator circuit 120, a register 122 for storing a reference value used in the comparator circuit 120, and a clamp pulse generator circuit 124.

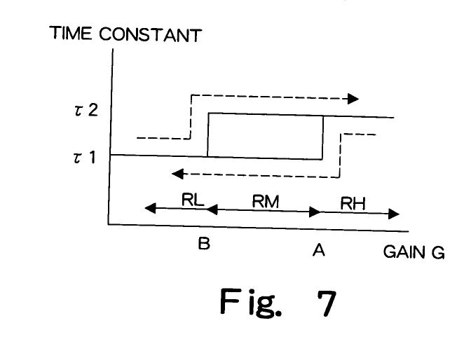

First and second reference values A and B (A>B) are designated by the register 122. The comparator circuit 120 compares the magnitudes of these reference values and the input gain value G. Based on the result of the comparison, the comparator circuit 120 selects either of two clamp time constants τ1 and τ2 (τ1<τ2). In the present example as shown in FIG. 7, the range including B and below is denoted RL, the range above B up to and including A is denoted RM, and the range above A is denoted RH. In a specific operation, the comparator circuit 120 selects and outputs time constant τ2 when the gain value G belongs in RH. In contrast, the comparator circuit 120 selects and outputs time constant τ1 when the gain value G belongs in RL. When the gain value G is within RM, time constant τ1 is output if the gain value G previously belonged in range RL, and, alternatively, time constant τ2 is output if the gain value G previously belonged in range RH. In other words, as shown in FIG. 7, time constant τ1 is maintained when the gain G is shifted from range RL to range RM, while time constant τ2 is maintained when the gain G is shifted from range RH to range RM. In this manner, the comparator circuit 120 exhibits a hysteresis characteristic in performing the comparison of the first and second reference values A and B to the gain value G.

The clamp pulse generator circuit 124 generates a clamp pulse CL which controls ON/OFF of the switch element in the clamp circuit 72. The clamp pulse generator circuit 124 changes the pulse width of the clamp pulse CL in accordance with the comparison result obtained in the comparator circuit 120, so as to change the clamp time constant used in the clamp circuit 72. More specifically, when the comparator circuit 120 outputs a judgment for increasing the clamp time constant, the clamp pulse generator circuit 124 operates to reduce the pulse width of the clamp pulse CL. Accordingly, the period during which the switch element in the clamp circuit 72 is turned on is reduced, which in turn reduces the period during which the signal line and the reference voltage source are connected. As a result, the clamp ability level of the clamp circuit 72 is set to a low value. On the other hand, when the comparator circuit 120 outputs a judgment for decreasing the clamp time constant, the clamp pulse generator circuit 124 operates to increase the pulse width of the clamp pulse CL. Accordingly, the period during which the switch element in the clamp circuit 72 is turned on is increased, which in turn increases the period during which the signal line and the reference voltage source are connected. As a result, the clamp ability level of the clamp circuit 72 is set to a high value.

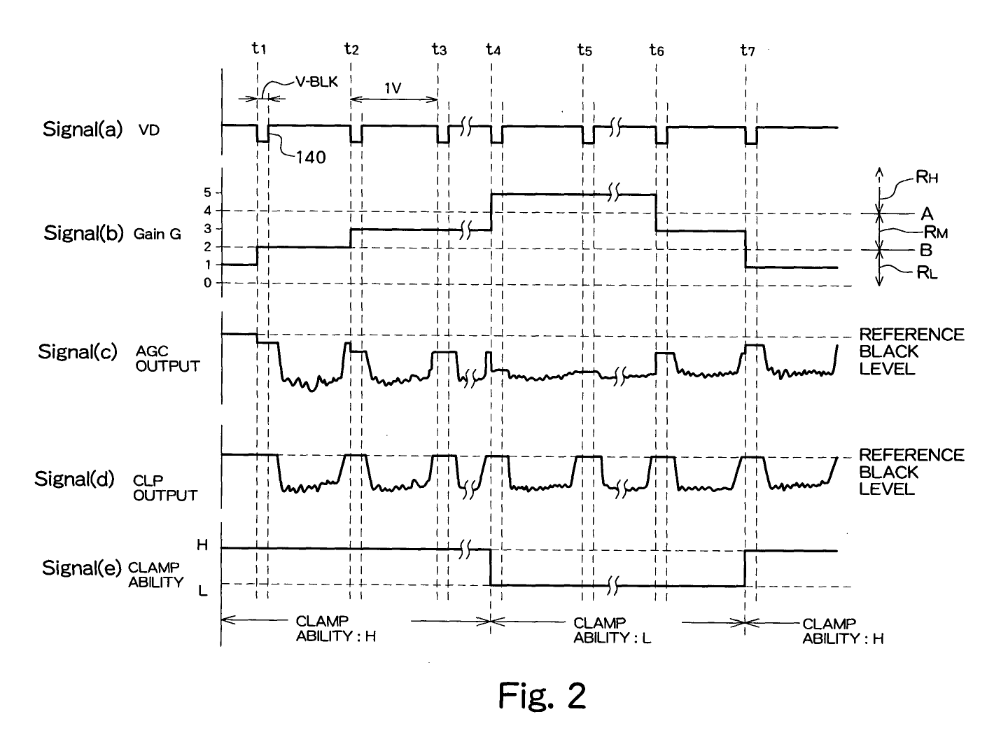

FIG. 2 is a timing chart illustrating an example operation of the present invention. The figure shows various signals over a plurality of vertical scanning periods. In FIG. 2, signal (a) denotes a vertical synchronization signal VD, signal (b) denotes the gain value G set in the AGC circuit 70, signal (c) denotes an AGC output signal output from the AGC circuit 70, signal (d) denotes a CLP output signal output from the clamp circuit 72, and graph (e) indicates the clamp ability level of the clamp circuit 72. Because the clamp ability level is proportional to the reciprocal of the clamp time constant as described above, changes in the clamp time constant generated in the clamp time constant setting circuit 58 can be understood from the graph (e).

Vertical synchronization pulses 140 included in the vertical synchronization signal VD correspond to vertical blanking periods (V-BLK), and an interval between the vertical synchronization pulses 140 corresponds to a vertical scanning period for one screen image. Throughout this vertical scanning period, the integration circuit 80 integrates the CLP output. In synchronization with the time point t1-t7 of completion of the vertical scanning period, the judging operation of the judgment circuit 82 and the gain setting operation of the gain setting circuit 56 are performed. For example, based on the integration result obtained in the integration circuit 80, it is determined at times t1, t2, and t4 that the image is darker than a reference level, and therefore the gain value G is increased. On the other hand, at times t6 and t7, it is determined that the image is brighter than a reference level, and the gain value G is decreased. The direct current level of the AGC output signal fluctuates in accordance with these changes in the gain value G. This can be seen in FIG. 2 in that the amount of deviation in the AGC output signal from the reference black level during the vertical blanking period is larger when the gain value G is larger. In the CLP output signal of FIG. 2, it can be seen that this deviation in the direct current level is corrected by the clamp circuit 72, and the signal level during the vertical blanking period is adjusted to the reference black level.

In the comparator circuit 120, “4” may be set as the first reference value A, and “2” may be set as the second reference value B. In this case, “0 and 1” correspond to the first range RL, “2 to 4” correspond to the second range RM, and “5” corresponds to the third range RH. The gain value G is successively increased from value “1” in effect before time t1, such that the gain change at time t4 places the gain value G in the third range RH exceeding the first reference value A. During this process, the comparator circuit 120 outputs time constant τ1 until time t4, and, after time t4, outputs time constant τ2 greater than τ1. In other words, at time t4, the clamp ability level is switched from a high level to a low level (refer to FIG. 2(e)).

Subsequently, the gain value G is successively decreased from value “5” from time t6 onward, such that the gain change at time t7 places the gain value G in the first range RL below the second reference value B. During this process, the comparator circuit 120 outputs time constant τ2 until time t7, then, after time t7, outputs time constant τ1. In other words, at time t7, the clamp ability level is switched from the low level back to the normal high level (refer to FIG. 2(e)).

Between time t1 and time t2, the gain value G is made equal to the second reference value B, shifting from the first range RL to the second range RM. In this case, time constant τ1 in effect at t1 is maintained so as to retain the clamp ability level setting. Similarly, time constant τ2 in effect at t6 is maintained even though the gain value is shifted from the third range RH to the second range RM between time t6 and t7.

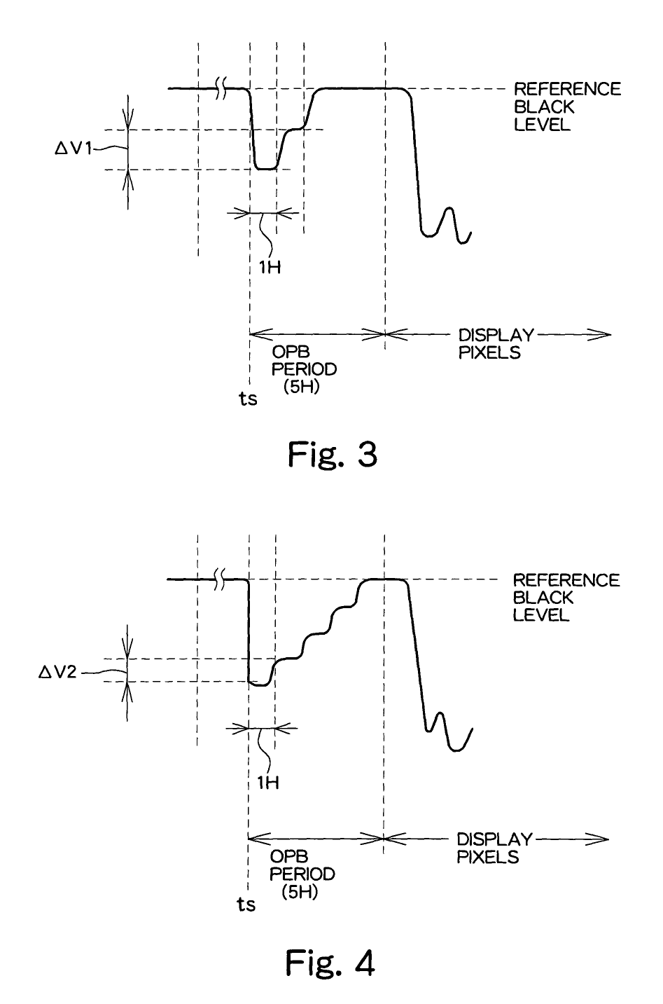

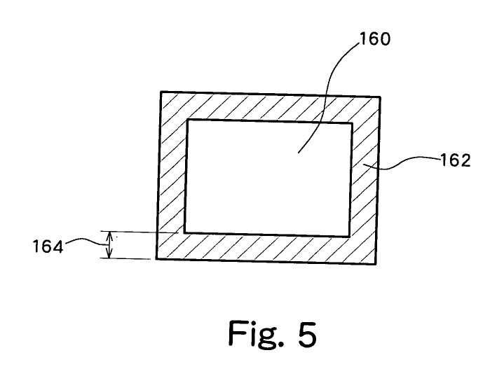

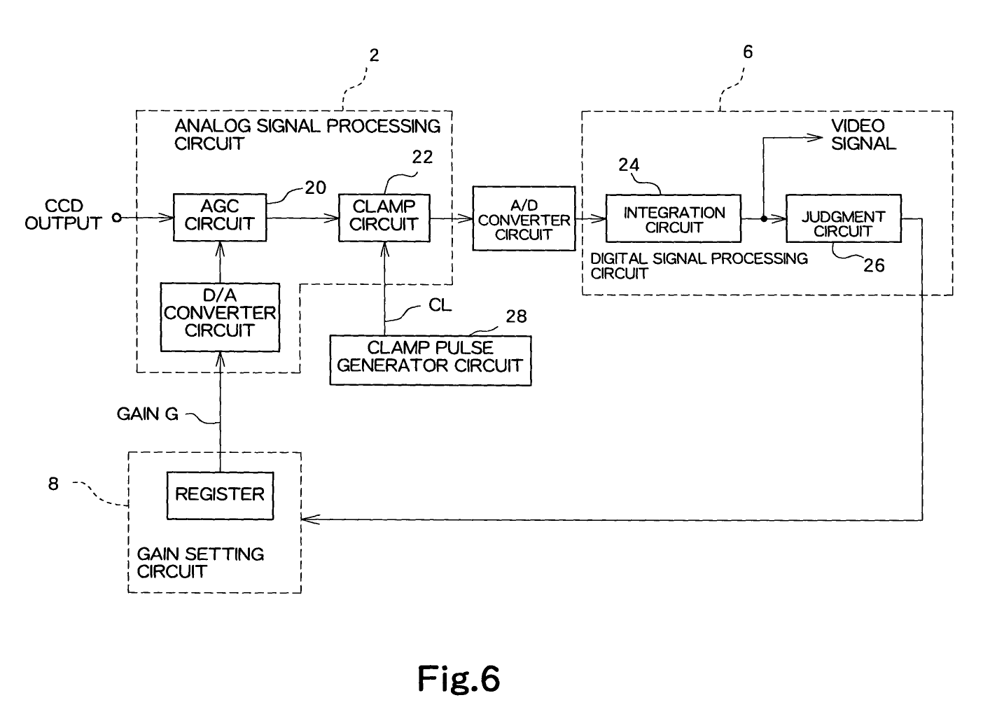

FIG. 3 shows an enlarged view of a waveform of the CLP output signal when the clamp ability level is set in a high level, while FIG. 4 shows an enlarged view of a waveform of a CLP output signal when the clamp ability level is set in a low level. Further, FIG. 5 shows a schematic diagram illustrating the pixel arrangement of a CCD image sensor which inputs a video signal into the present device. In FIG. 5, a CCD screen image is shown including an OPB region 162 provided surrounding an effective pixel region 160. In a specific example, five lines of OPB region 164 may be provided at the bottom portion (i.e., the portion that is read out first in a video signal for one screen image) of the screen image. The 5H OPB periods shown in FIGS. 3 and 4 correspond to the OPB region 164.

FIGS. 3 and 4 each illustrate a CLP output signal. In both figures, at the timing ts in which the gain value G is changed, the CLP output signal drastically drops from the maintained reference black level because of a change in the direct current level of the AGC output. Subsequently, as the clamp circuit 72 performs a clamp operation for each line, the direct current level of the CLP output signal is gradually restored to the reference black level in successive 1H periods. The waveform subsequent to the OPB period is the signal waveform corresponding to a line in the effective pixel region 160.

When the clamp ability level is set high, the restored potential width ΔV1 achieved in one clamp operation is large, such that the reference black level can be speedily restored in a small number of operations (two operations in the example of FIG. 3). In contrast, when the clamp ability level is set low, the restored potential width ΔV2 achieved in one clamp operation is small, such that the reference black level is restored in a relatively large number of operations (four operations in the example of FIG. 4).

In the present embodiment described above and shown in FIG. 2, the gain G is adjusted every vertical period in accordance with the state of the video signal, and the clamp time constant τ is set according to the adjusted gain G. Accordingly, when performing clamping during the OPB period (in the region 162 of FIG. 5) within each horizontal scanning period, the clamp ability level is set in accordance with the gain G. Specifically, when the gain G is relatively large, the clamp ability level is set to low so as to minimize the influence of noise. When the gain G is relatively small, the clamp ability level is set to high so as to improve convergence to the reference black level.

According to a video signal processor of the present embodiment, during clamping of a signal for correcting a deviation in the direct current level generated due to factors such as the switching of the gain value of an amplifier circuit in the AGC circuit or the like, the clamp time constant is set at a larger value when the gain is set relatively large. As a result, clamping can be executed in a gradual manner to suppress transverse noise, thereby ensuring the quality of the displayed image.

What is claimd is:

1. A video signal processor circuit, comprising:
an amplifier circuit for amplifying by a predetermined gain a video signal that is continuous for a unit of one screen image; and
a clamp circuit for clamping a reference level of the amplified video signal to a predetermined level; wherein
a time constant used for the clamping of the video signal in the clamp circuit is set in accordance with the gain of the amplifier circuit.

2. The video signal processor circuit as defined in claim 1, wherein
the clamp circuit clamps the video signal in response to a clamp pulse, and
a pulse width of the clamp pulse is adjusted in accordance with the gain of the amplifier circuit so as to control the clamp time constant.

3. The video signal processor circuit as defined in claim 2, further comprising:
a comparison circuit for comparing the gain value of the amplifier circuit to a predetermined reference value; and
a clamp pulse generating circuit for adjusting the pulse width of the clamp pulse in accordance with a comparison result obtained in the comparison circuit.

4. The video signal processor circuit as defined in claim 3, wherein
the pulse width of the clamp pulse generated in the clamp pulse generating circuit is varied in a stepwise manner.

5. The video signal processor circuit as defined in claim 4, wherein
the comparison circuit includes a first reference value and a second reference value, and exhibits a hysteresis characteristic when performing comparison of the first and second reference values to the gain value.

6. The video signal processor circuit as defined in claim 1, wherein
the gain of the amplifier circuit is set in accordance with a direct current level of the video signal for one screen image, and maintained at a constant value with respect to the video signal for the subsequent one screen image.

7. The video signal processor circuit as defined in claim 6, wherein
the clamp time constant used in the clamp circuit is set in accordance with the gain of the amplifier circuit for the current one screen image, and maintained at a constant value with respect to the video signal for the one screen image.
